(19) United States
(12) Patent Application Publication
(10) Pub. No.: US 2017/0337520 A1
(43) Pub. Date: Nov. 23, 2017

(54) SYSTEM AND METHOD FOR TRANSMISSION OF APPOINTMENT DATA

(71) Applicants: Sandra SPENCER, Melbourne, FL (US); William SHOAFF, Melbourne, FL (US)

(72) Inventors: Sandra SPENCER, Melbourne, FL (US); William SHOAFF, Melbourne, FL (US)

(21) Appl. No.: 15/158,114

(22) Filed: May 18, 2016

(51) Int. Cl. G06Q 10/10; H04L 29/08; G06Q 50/22

(52) U.S. Cl. CPC G06Q 10/1095; G06Q 50/22; H04L 67/12

(57) ABSTRACT

A method for transmission of appointment data includes receiving an available appointment at a server sent from a medical provider over a communications network. The server includes a processor and a memory that stores patient data and medical provider data. The processor is configured to prioritize a list of waiting patients for the available appointment based upon a priority value determined from the patient data and the medical provider data, identify a compatible patient for the available appointment based upon a highest priority on the list of waiting patients, generate an appointment alert that contains a date and time for the available appointment, format the appointment alert according to an appointment format, and transmit the formatted appointment alert over a wireless communication channel to a wireless device associated with the compatible patient based upon a destination address associated therewith.

### TECHNICAL FIELD

The present invention relates to the field of scheduling systems, and, more particularly, to a system for transmission of appointment data and related methods.

### BACKGROUND

Doctors see patients according to a schedule of appointments. Often appointments are scheduled months in advance and it is common for a patient to cancel an appointment. When this happens the doctor fills the empty slot with the next patient on a wait list. To accomplish this rescheduling, the patients on the wait list are contacted in order to see if the cancelled appointment may be filled. If the first patient is not available to fill the slot, then the next patient on the wait list is contacted. A shortcoming of the current scheduling systems is that the patients on the wait list are selected in chronological order.

For example, the first patient on the wait list with an appointment for the following week is contacted first to fill the cancelled appointment slot. If that patient is not available, then the patient in chronological order with the next appointment time is contacted and so forth. However, each patient on the waiting list may not have the same symptoms, same insurance provider, or the same reason for the appointment, for example, as the patient that cancelled. In addition, it takes time for staff to call each patient on the wait list and wait to receive a response.

### SUMMARY

One embodiment provides a method for transmission of appointment data. The method includes receiving an available appointment at a server sent from a medical provider over a communications network. The server includes a processor and a memory that stores patient data and medical provider data. The processor is configured to prioritize a list of waiting patients for the available appointment based upon a priority value determined from the patient data and the medical provider data, identify a compatible patient for the available appointment based upon a highest priority on the list of waiting patients, generate an appointment alert that contains a date and time for the available appointment, format the appointment alert according to an appointment format, and transmit the formatted appointment alert over a wireless communication channel to a wireless device associated with the compatible patient based upon a destination address associated therewith.

Another embodiment provides a system for transmission of appointment data. The system includes a server comprising a processor and a memory coupled thereto, where the server is configured to receive an available appointment sent from a medical provider over a communications network. The memory is configured to store patient data and medical provider data, and the processor is configured to prioritize a list of waiting patients for the available appointment based upon a priority value determined from the patient data and the medical provider data. In addition, the processor is configured to identify a compatible patient for the available appointment based upon a highest priority on the list of waiting patients, generate an appointment alert that contains a date and time for the available appointment, format the appointment alert according to an appointment format, and transmit the formatted appointment alert over a wireless communication channel to a wireless device associated with the compatible patient based upon a destination address associated therewith.

Another embodiment provides a non-transitory computer-readable medium for operating a system for transmission of appointment data. The system includes a server configured to receive an available appointment sent from a medical provider over a communications network, and a memory configured to store patient data and medical provider data. The non-transitory computer-readable medium includes computer-readable instructions for performing steps of prioritizing a list of waiting patients for the available appointment based upon a priority value determined from the patient data and the medical provider data, identifying a compatible patient for the available appointment based upon a highest priority on the list of waiting patients, generating an appointment alert that contains a date and time for the available appointment, formatting the appointment alert according to an appointment format, and transmitting the formatted appointment alert over a wireless communication channel to a wireless device associated with the compatible patient based upon a destination address associated therewith.

### BRIEF DESCRIPTION OF THE DRAWINGS

FIG. 1 is a flow diagram of a method for transmission of appointment data according to the invention;

FIG. 2 is a block diagram of a system for transmission of appointment data according to the invention;

FIG. 3 is an illustration of a patient mobile application allowing a patient to receive text messages to accept a time slot for a cancelled appointment according to the invention;

FIG. 4 is an illustration of the patient mobile application displaying exemplary terms of service according to the invention;

FIG. 5 is an illustration of the patient mobile application displaying a logout page according to the invention;

FIG. 6 is an illustration of the patient mobile application displaying and offering an available appointment for a patient to decline or accept according to the invention;

FIG. 7 is an illustration of the patient mobile application displaying a dialog of text messages with the patient when the patient accepts the available appointment according to the invention;

FIG. 8 is an illustration of the patient mobile application displaying a dialog of text messages with the patient when the patient declines the available appointment according to the invention; and

FIG. 9 is an illustration of the patient mobile application displaying a dialog of text messages with the patient when the patient does not respond within a duration of time and the offer of the available appointment is withdrawn according to the invention.

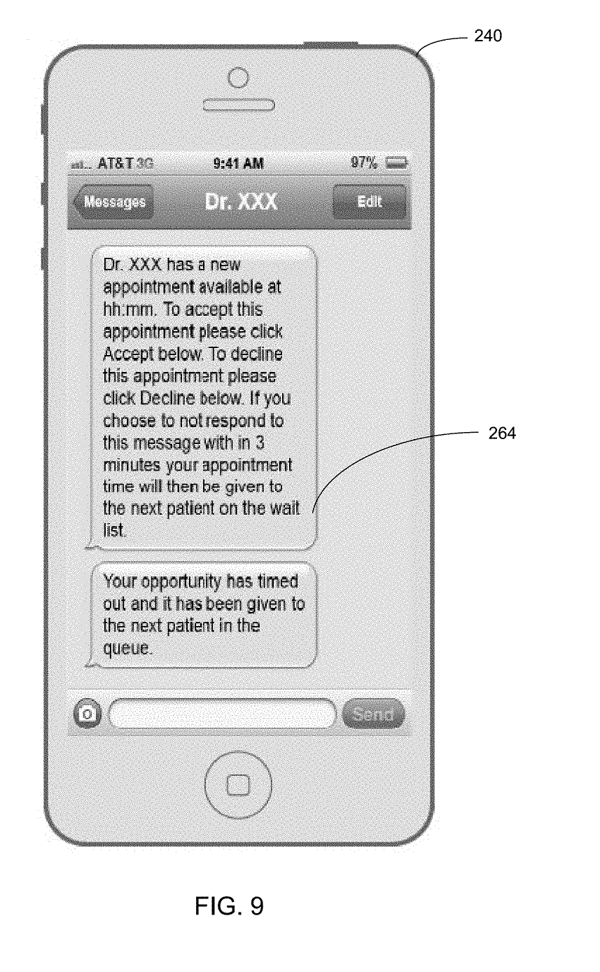

### DETAILED DESCRIPTION

Embodiments of the present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The embodiments disclosed are stated in terms of a doctor-patient relationship and using the doctor-patient scenario to illustrate the problems with existing systems. For example, an appointment is typically used to designate a time and a place for a meeting with a doctor.

File descriptions may be used to save and store the appointments electronically. One type of known system that uses the export and import file descriptions is the Epic system. The Epic system provides the basic structure of the files for export and import. The fields may also be in the present method and system.

The logic flow of a particular embodiment of the method may be described as follows:
a notice of an available appointment is sent from a medical provider (e.g. a doctor's office), perhaps using the Epic system, to the server,
a list of waiting patients are prioritized for the available appointment based upon a priority value determined from patient data and medical provider data,
a compatible patient is identified for the available appointment based upon a highest priority on the list of waiting patients,
an appointment alert is generated that contains a date and time for the available appointment,
the appointment alert is formatted according to an appointment format,
the formatted appointment alert is transmitted to patients in priority order, subject to constraints, until the appointment is filled or it can be determined that the appointment cannot be filled (these cases may be determined by result codes sent from the medical provider to the system), and
the final results in the search to fill the available appointment are returned to the medical provider that initiated the search.

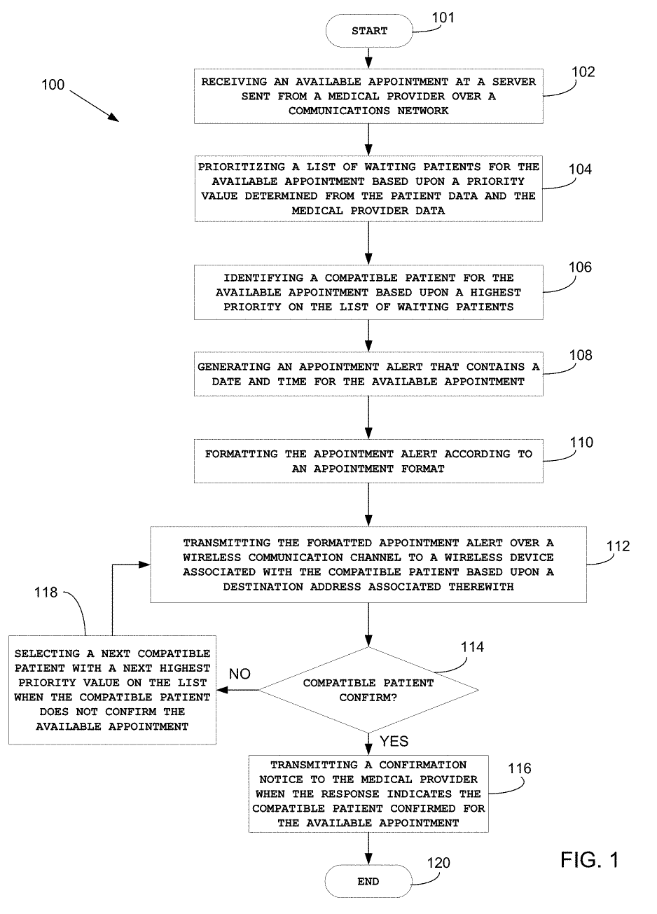

An exemplary flow diagram 100 of the method is illustrated in FIG. 1. From the start, at block 101, The method includes, at block 102, receiving an available appointment at a server sent from a medical provider over a communications network. Moving to block 104, the method includes prioritizing a list of waiting patients for the available appointment based upon a priority value determined from patient data and medical provider data. At block 106, the method includes identifying a compatible patient for the available appointment based upon a highest priority on the list of waiting patients, and generating an appointment alert that contains a date and time for the available appointment, at block 108. In addition, the method includes formatting the appointment alert according to an appointment format, at block 110, and transmitting the formatted appointment alert over a wireless communication channel to a wireless device associated with the compatible patient based upon a destination address associated therewith, at block 112. The method includes receiving a response as to whether the patient confirmed the appointment, at block 114, and transmitting a confirmation notice to the medical provider, at block 116, when the response indicates the compatible patient confirmed for the available appointment. If the patient does not confirm the appointment, at block 114, then the method includes selecting a next compatible patient with a next highest priority value on the list, at block 118, before stopping at block 120.

A system 210 for transmission of appointment data includes a server 212 comprising a processor and a memory coupled thereto, where the server 212 is configured to receive an available appointment sent from a medical provider using a scheduling system 232 over a communications network. The server 212 is configured to store patient data and medical provider data, and the server 212 is configured to prioritize a list of waiting patients for the available appointment based upon a priority value determined from the patient data and the medical provider data. In addition, the server 212 is configured to identify a compatible patient for the available appointment based upon a highest priority on the list of waiting patients, generate an appointment alert that contains a date and time for the available appointment, format the appointment alert according to an appointment format, and transmit the formatted appointment alert over a wireless communication channel to a wireless device having a mobile patient application 228 thereon associated with the compatible patient based upon a destination address associated therewith.

Another embodiment provides a non-transitory computer-readable medium for operating a system 210 for transmission of appointment data. The system 210 includes a server 212 configured to receive an available appointment sent from a medical provider using a scheduling system 232 over a communications network, and a memory configured to store patient data and medical provider data. The non-transitory computer-readable medium includes computer-readable instructions for causing the server 212 having a processor cooperating with the memory to perform steps of prioritizing a list of waiting patients for the available appointment based upon a priority value determined from the patient data and the medical provider data, identifying a compatible patient for the available appointment based upon a highest priority on the list of waiting patients, generating an appointment alert that contains a date and time for the available appointment, formatting the appointment alert according to an appointment format, and transmitting the formatted appointment alert over a wireless communication channel to a wireless device having a mobile patient application 228 thereon associated with the compatible patient based upon a destination address associated therewith.

The patient data includes at least one of the destination address of the patient (e.g., a cell phone number associated with the compatible patient), disease, and insurance provider on the list. The appointment alert may include a universal resource locator (URL) to enable connection over a communications network by the compatible patient to the medical provider having the available appointment. The primary information needed about the cancelled and now available appointment, includes an appointment ID used in returning the results of a search, a doctor ID used to identify a list of waiting patients, the date of the available appointment in YYYYMMDD format, the time of the available appointment in HHMMSS format relative to the local time zone, and the expected length of the available appointment in HHMMSS format.

When a patient is contacted using the patient mobile application, there are three possible outcomes in a particular embodiment. One outcome is that the patient confirms he or she will accept the appointment. This may be represented by the value “1”. A second outcome is that the patient states he or she will not accept the appointment. This outcome may be represented by the value “2”. The third outcome is that the patient provides no response within a timeout period. This outcome may be represented by the value “3”. The timeout window could be set for three minutes, for example. The system allows this value to be customized.

In the last two outcomes described above, the system will continue to query patients on the wait list until an appointment is filled or it is determined the appointment cannot be filled.

The medical provider attempting to fill the appointment is informed of the result. In the case that an appointment is confirmed, the medical provider needs to know the appointment ID and the identifier of the accepting patient. The appointment ID may determine the most relevant aspects of the appointment. For example, it may determine the doctor, the day and time, the length, and so on. The medical provider and the system may maintain a consistent record of doctor and patient identifiers. In particular, the system may store the following information:
practice (department) identifiers and identifiers of doctors in this practice;
the diseases (symptoms) treated by the practice; and
the insurance providers the practice accepts.
For a waiting patient, the system may store:
their name and an identifying number;
their mobile phone number and their service provider; and
their email address.

Finally, the system may correlate between the doctor and patient the reason they are waiting for an appointment, the symptoms they have, the expected length of an appointment, and their insurance provider, for example.

Both the doctor and patient have priorities and constraints. For the patient, most often, the priority is as soon as possible. For the doctor, priorities may be more complex. For example, the doctor may have a customizable wait list of patients who have conditions to consider when searching for a patient to fill a cancelled appointment. These conditions may be a patient's health records, and health characteristics. The doctor may prioritize appointments based on their knowledge of the seriousness of given symptoms given the patient's health records. Another priority may be based on the reason for a patient's visit, for example, the patient may have become sick, or a follow-up from a previous appointment or an emergency room or walking clinic visit, or a routine annual check-up. The patient's insurance provider may affect the priority as well because certain insurance providers may provide better service than others. The system allows the doctor to weigh insurance providers when determining the overall priority of waiting patients. There may also be doctor defined/patient suggested categories. Therefore, the system also supports adding an unbounded “other” category where new properties can be defined.

There are also constraints that may be considered before contacting a patient to fill a cancelled appointment. For example, the system may be informed of the expected length of the cancelled appointment by the medical provider. If the expected length exceeds the time allocated to a waiting patient, that patient should not be contacted. If the location of a waiting patient can be determined, that too, can determine whether or not a waiting patient should be contacted.

The priority of a waiting patient may be computed by the formula

$$P = \frac{{w}_{i} {w}_{pi} + {w}_{s} ( average ( {w}_{ps} ) ) + {w}_{r} {w}_{pr}}{{w}_{i} + {w}_{s} + {w}_{r}}$$

where wi, ws, and wr are primary weights for the insurance provider, the patient's symptoms, and the reason for the visit. The secondary weights are wpi, wps, and wpr for the particular symptoms, the weight assigned to a particular insurance provider, and a particular reason for a visit, respectively.

How these weights can be set and how they can be interpreted are described more fully below in setting priorities in the user interface and the implementation of priorities. The system may also assume that smaller values imply higher priority.

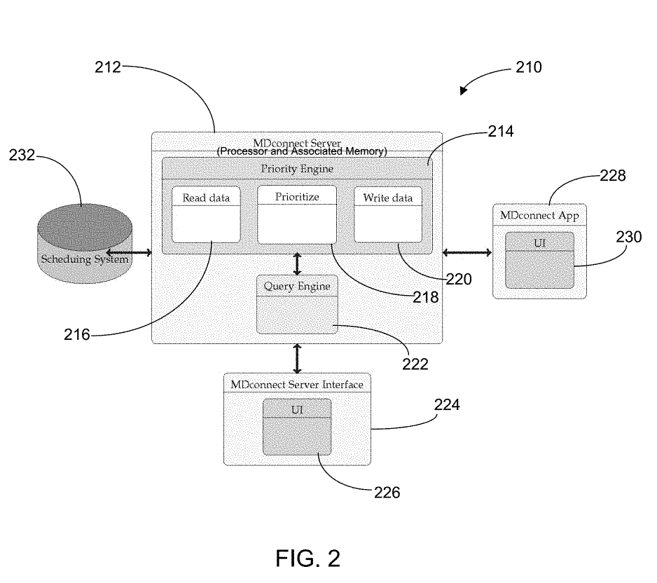

Referring now to FIG. 2, the system 210 includes a server 212 (priority engine 214 and a query engine 216), a patient mobile application 228, and a server user interface 224. The priority and query engines 214, 216 and user interface 224 may be written in Haskell. The patient mobile application 228 may be written in Swift.

The priority engine 214 includes a processor coupled to a memory storing a read module 216, a priority module 218, and a write data module 220, and is configured to:

read a list of waiting patients using the read module 216;

calculate a priority for each waiting patient based upon defined priority ratings of insurance providers, symptoms, visit reasons, among other things using the priority module 218; and

establish, use, and store a prioritized list of waiting patients using the write data module 220.

For example, an outline for the code for the priority engine 214 may include:

import modules as needed;

define types as needed;

construct the main module; and

construct auxiliary functions as needed.

This code is expanded in these code portions:

(MDconnectPriorityEngine)≡

(Imports)

(Types)

(Main priority)

(Auxiliary functions).

Besides the standard Prelude, there may be additional Haskell modules that may be needed to be imported, for example System.IO to handle reading and writing files. Defining the domain specific type system developed to implement may include:

(Imports)≡
import System.IO

The Main priority module 218 that may be expanded stepwise includes:

(Main priority)≡
main=do
   (Read the insurance plans accepted by the practice)
   (Read reasons for a visit)
   (Read the diseases treated by the practice)
   (Read practice defined weights for insurers, visit reasons and diseases)
   (Read the list of waiting patients)
   (Convert wait list into a priority queue)
   (Clean up: Close the open file handles)

The treated diseases may be stored in a flat text file named “Diseases.txt.” It is a list of the form:

Int

String

Int

String

.

.

.

where each integer (Int) describes the severity of the disease (String). Smaller integers have higher priority. The file may be created by the medical provider's staff using the system's graphical user interface 226 stored in the server interface 224, and may be modified.

(Read the diseases treated by the practice)≡
diseases<-openFile “Diseases.txt” ReadMode
diseaseList<-readTuplesToList diseases [ ]
print diseaseList

The insurance plans may be stored in a flat text file named “Providers.txt.” It may have the same structures as the “Diseases.txt” file, where each integer (Int) describes the priority of the plan (String). Smaller integers indicate a more desireable plan for the medical provider. The file may be created by the medical provider's staff using the system's graphical user interface 226, and it may also be modified.

(Read the insurance plans accepted by the practice)≡
providers<-openFile “Providers.txt” ReadMode
providersList<-readTuplesToList providers [ ]
print providersList

There may be several reasons why a patient needs to see a doctor. These reasons may be stored in a flat text file named “VisitReasonstxt.” It may have the same structures as the “Diseases.txt” file.

(Read reasons for a visit)≡
reasons<-openFile “VisitReasons.txt” ReadMode
reasonsList<-readTuplesToList providers [ ]
print reasonsList

As described above, the insurer, reason, and diseases may all be weighted to compute a final priority. These weights are read from “Weights.txt”.

(Read practice defined weights for insurers, visit reasons and diseases)≡
weights<-openFile “Weights.txt” ReadMode
wInsurer<-hGetLine weights
wReason<-hGetLine weights
wComplaints<-hGetLine weights
let priorities=map read [wInsurer, wReason, wComplaints]

The waiting patients may be stored in a flat text file named “Patients.txt.” The structure of this file may be more complex, and so a new function may be needed to read it. The structure of the file and how it is read is described below.

(Read the list of waiting patients)≡
patients<-openFile “Patients.txt” ReadMode
patientList<-readWaitingPatients patients [ ]
(Convert wait list into a priority queue)≡
priorityQueue<-ConvertListToQueue patientList
To clean up, close all open files.
(Clean up: Close the open file handles)≡
hClose providers
hClose reasons
hClose diseases
hClose weights
hClose patients
(Auxiliary functions)≡
(Store the diseases and insurance provides in lists of tuples)
(Store the waiting patients in a list)

Since both the diseases and medical providers files may have the same format, a single function may be used to read them both. For example, the code when executed causes a handle to a file to open for reading and a list to provide input to readTuplesToList. The completed list may be returned as an IO action that contains a list of ordered pairs (priority, field). When the end-of-file is reached, the list may be returned. Otherwise, the next priority (Int) and field (String) is retrieved from the file, and a helper function addTupleToList inserts the pair at the head of the list. readTuplesToList calls itself recursively until the file has been completely read.

(Store the diseases and insurance provides in lists of tuples)≡
readTuplesToList::Handle->[(Int, String)]->IO [(Int, String)]
readTuplesToList fHandle list=
   do fHandleEOF<-hIsEOF fHandle
      if fHandleEOF
         then return list
         else do priority<-hGetLine fHandle
         field<-hGetLine fHandle
         list<-addTupleToList (read priority, field) list readTuplesToList fHandle list
addTupleToList::(Int, String)->[(Int, String)]->IO [(Int, String)]
addTupleToList (n, m) [ ]=return [(n,m)]
addTupleToList (n, m) list=return ((n,m):list)

Describing the characteristics of a patient waiting for a cancelled appointment may be more difficult. For example, some types of characteristics are defined below to expose the domain specific problem.
(Types)≡
type AID=Int—A unique appointment identifier
type DID=Int—A unique physician identifier
type PID=Int—A unique patient identifier type FirstName=String—Patient's first name
type MiddelName=String—Patient's middle name type LastName=String—Patient's last name type Phone—String—Format xxx-xxx-xxxx
type PhoneCompany=String—The patient's phone company provider type Email—String—Patient's email address
type Insurer=String—Patient's insurance provider
type VisitType=String—e.g. a physical, follow-up, or sickness type Length—Int—Appointment expected length in minutes type Symptoms=String—A list of the patient's primary diseases

The appointment data may be partitioned into two lists stored in a 2-tuple:
a list of numbers: [AID, DID, PID, Length], and
a list of strings: [FirstName, MiddleName, LastName, Phone, Company, Email, Insurer, VisitType, Symptoms]

This will make accessing the data more simple.
(Types)+S
type WaitingPatient=([Int], [String])
(Store the waiting patients in a list)≡
readWaitingPatients::Handle->[WaitingPatient]->IO [WaitingPatient]

readWaitingPatients fHandle list=
do fHandleEOF<-hIsEOF fHandle
   if fHandleEOF
      then return list
      else do aid<-hGetLine fHandle
      did<-hGetLine fHandle
      pid<-hGetLine fHandle
      first<-hGetLine fHandle
      middle<-hGetLine fHandle
      last<-hGetLine fHandle
      phone<-hGetLine fHandle
      company<-hGetLine fHandle
      email<-hGetLine fHandle
      insurer<-hGetLine fHandle
      vtype<-hGetLine fHandle
      length<-hGetLine fHandle
      symptoms<-hGetLine fHandle
      list<-addPatientToList
   ([read aid, read did, read pid, read length], [first, read middle, last, phone, company, email, insurer, vtype, symptoms]) list
readWaitingPatients fHandle list

addPatientToList:: WaitingPatient->[WaitingPatient]->IO [WaitingPatient]

addPatientToList patient [ ]=return [patient]

addPatientToList patient list=return (patient:list)

Given a patient's disease(s), reason for a visit, and insurance provider a priority may be calculated. The priority function is described below. If given one of these characteristics, it may be looked up in a corresponding list and the practice supplied value for it may be used.
(Auxiliary functions)+≡
(Find a tuple in a list by matching the string 23b)
(Compute a patient's priority)

Here, the function that finds a pair (Int, String)] in a given list of pairs. Given a string s to find and a list of tuples, list comprehension may be used to step through the list until s is found. Since it could happen that s is not in the list, error checking is built in.
(Find a tuple in a list by matching the string)≡
findInList::String->[(Int,String)]->(Int, String)
findInList s list=let d=[x|x<-list, s==snd x]
   in if null d
   then (−1, “None”) else head d

Below is an illustrative example to show how priorities may be calculated in accordance with an embodiment of the invention. A primary weight may be assigned to at least one of an insurance provider, a symptom, and a reason for an appointment, for a waiting patient.

For example, the patient has three symptoms with physician defined seriousness: (5, Bronchitis), (3, Asthma) and (7, Pleural Effusion);
the patient is scheduled for a follow-up visit: (3, follow-up);
the patient's insurance provider is Aetna with a practice defined score of 4; and
finally, the doctor works in a private practice and judges insurance as most important (wi=1), disease symptoms secondary (ws=2), and the reason for the visit as tertiary (wr=3).

In this case, the patient's priority is computed as

$$\begin{matrix}priority = \frac{( 1 \times 4 ) + ( 2 \times \frac{5 + 3 + 7}{3} ) + ( 3 \times 3 )}{1 + 2 + 3} \\ = \frac{4 + 10 + 9}{1 + 2 + 3} ( interger division ) \\ = 3\end{matrix}$$

In addition, a secondary weight may be assigned to at least one of a particular insurance provider, a particular symptom, and a particular reason for the appointment. For example, a doctor wanting to weigh insurance highly could set wₛ=wᵣ=0 effectively only considering the insurance provider. In an academic practice, the insurance provider may be of no concern. In this case, the weights might be set as wᵢ=0, wₛ=1, and wᵣ=2, giving a priority of

$$priority = \frac{( 0 \times 4 ) + ( 1 \times \frac{5 + 3 + 7}{3} ) + ( 2 \times 3 )}{1 + 2 + 3} = \frac{11}{6} = 1$$

In general, priorities are set by

$$priority = \frac{{w}_{i} {w}_{pi} + {w}_{s} ( average ( {w}_{ps} ) ) + {w}_{r} {w}_{pr}}{{w}_{i} + {w}_{s} + {w}_{r}}$$

Integer arithmetic is used in computing the symptom average and the overall priority and assign the priority value to the waiting patient.
(Compute a patient's priority)≡
(Get complaints and average their priority)
computePriority:: [Int], [String])->[Int]->Int
computePriority patient weights=let insurance=(weights !! 0)*fst (findInList ((snd patient) !! 6)
   reason=(weights !! 1)*(snd patient) !! 7))
   complaints=(weights !! 2)*complaintsPriority patient
   in (insurance+reason+complaints) ‘div’ (sum weights)

A patient may have several complaints. For example, take a waiting patient record, that is of type ([Integer], [String]) and pull out the [String], then take the eighth field, the String of diseases. This may be converted into a list illnessList of separate diseases using words. This list is stepped through to find each particular illness in the diseases treated by the practice, and take the priority associated with the disease. These disease priorities are totaled in order to return the average.
(Get complaints and average their priority 25a)≡
complaintsPriority:: ([Integer], [String])->Int
complaintsPriority patient=let complaints=(snd patient) !! 8

complaintList=words complaints
in sum [a|ill<-complaintList,
let a=fst (findInList ill complaints)]‘div’ (length complaintList)

A function may be constructed that converts the waiting patient list into a priority queue. The function can be added to the collection of auxiliary functions.
(Auxiliary functions)+≡
   (Store the list of waiting patients in a priority queue)
(Store the list of waiting patients in a priority queue)≡−ConvertListToQueue::[WaitingPatient]->IO PriorityQueue

The query engine 222 is designed to identify a prospective waiting patient (e.g. compatible) on the list. In particular, the query engine 222 will recognize that a cancellation has occurred and call the priority engine 214, which returns a prospective waiting patient who is a compatible patient. The query engine 222 may also send a notification to the waiting patient using the patient mobile application 228 and wait for a response. The query engine 222 may also confirm and record the new appointment information. In addition, the query engine 222 may deny or timeout, and re-query the priority engine 214.

An outline for the query engine 222 code follows a common framework as follows:
import modules as needed;
define types as needed;
construct the main module; and
construct auxiliary functions as needed.
(MDconnectQueryEngine)≡
(Imports)
(Types)
(Main)
(Auxiliary functions)

Besides the standard Prelude, there may be additional Haskell modules that may need to be imported. For example Control.Monad to handle interactions with worlds.
(Imports)≡
   import Control.Monad
   import Data.Char
(Types)≡
(Auxiliary functions)≡

The Main module may be expanded stepwise.
(Main)≡
   main=do
      (Listen for input)
      (Act based on input)
   “Cancel” AID, Day, Time, Length, DID
   “Accept” PID
   “Decline” PID
   “SignIn” PID
(Listen for input)≡
   line<-getLine
   let code=head $ words line
(Act based on input)≡
case code of
   “Cancel”->(Call priority engine to get prospective patient (never defined))
   “Accept”->(Report that the appointment can be rescheduled (never defined))
   “Decline”->(The next patient in the queue (never defined))
   “SignIn”->(Process sign in (never defined))
   “TermsOfUse”->(Accept of deny terms of use (never defined))
   “Logout”->(Loguout of system (never defined))
      ->error $ “Unrecognized query instruction word:”++code
(Check this)≡
   putStrLn “Really Call priority engine”
(Prioritize wait list)≡
(Return first waiting patient)
(Check time and location)
(Check time and location)≡
   if (expectedLength<=openLength) && locationServices True

The functionally of the patient mobile application 228 and its user interface 230 is straightforward. One goal is to store little information, if any, on the patient's phone, in particular, no medical knowledge.

An off-line process may be completed before a patient registers for appointment notification services. For example, the patient may be required to be an established patient with the doctor's practice. This includes recording the following minimal information about a patient, most of which may be stored in the medical provider's scheduling system 232, as follows:
name (establishes a PID);
email address that they will use to register to help ensure health care privacy and to match a patient with their patient ID with minimal shared knowledge; and
notifications and text messages to inform the patient about appointments.

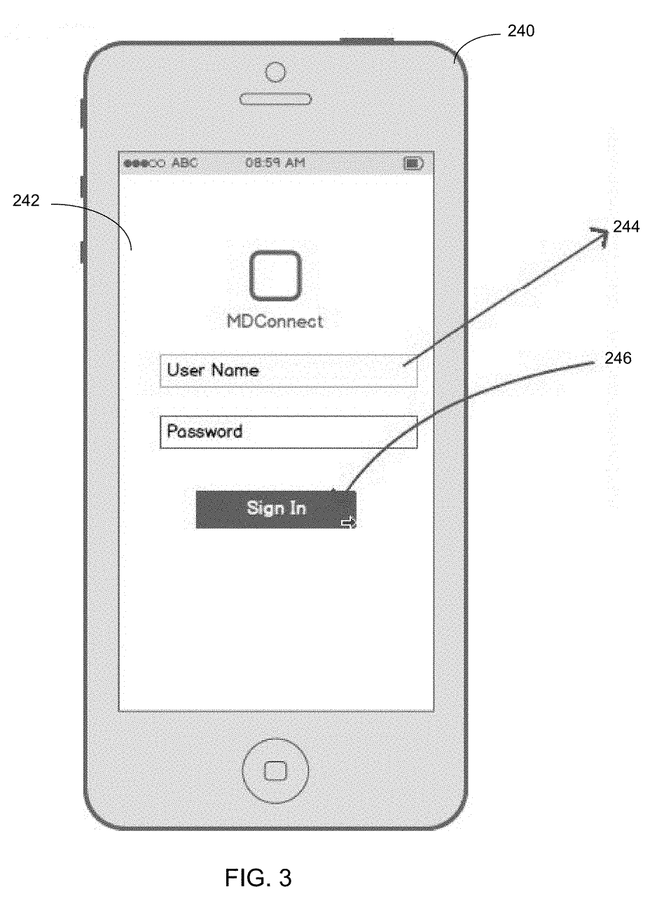

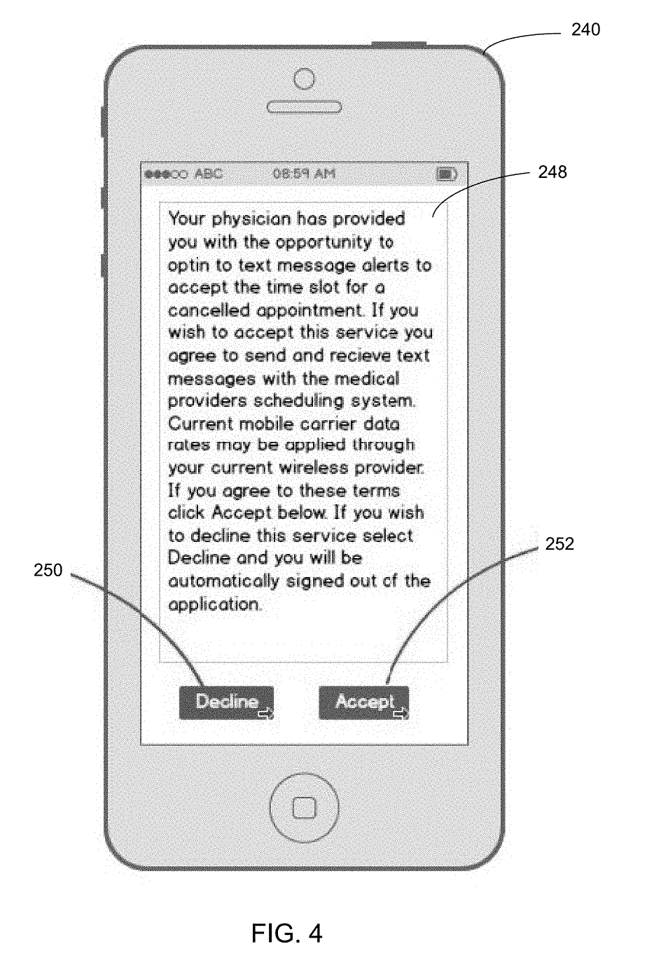

Referring now to FIG. 3, the patient mobile application may be installed on a wireless or mobile device in order to view the appointment alerts. The appointment alert activates the patient mobile application to cause the appointment alert to display on the mobile (or wireless) device. To use the patient mobile application 228, the patient signs in by entering a user name 244 and a password displayed using a mobile device 240. Clicking the sign in tab 246 will cause the Terms of Use to display on the screen. First time patients may be required to accept the Terms of Use 248, which an example is shown in FIG. 4. Should the terms of use change, the registered patients may be required to re-accept the Terms of Use 248.

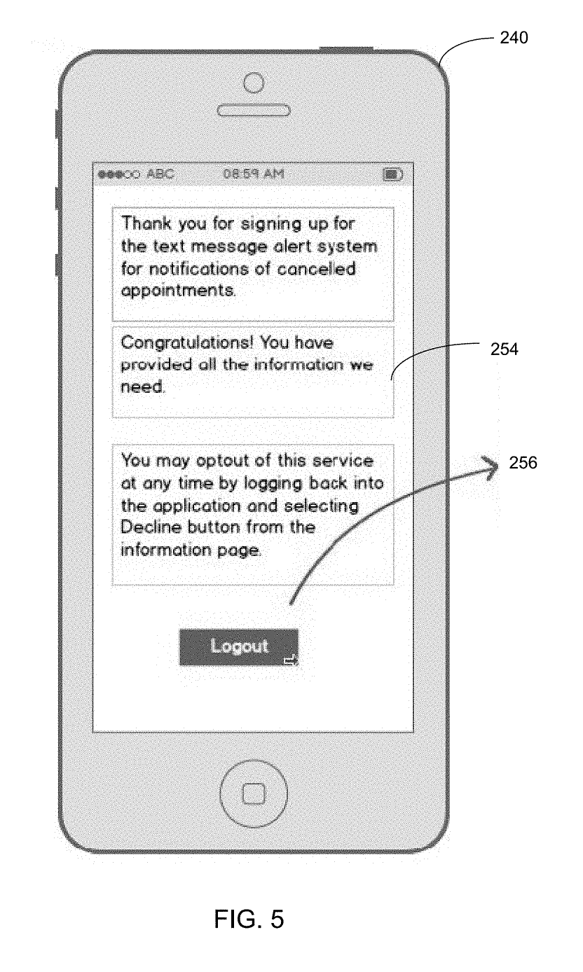

Once the patient has signed up to receive the text message appointment alerts for notifications of available appointments, a confirmation screen 254 is displayed as shown in FIG. 5. If the patient selects to click the logout tab 256, then the sign in screen shown in FIG. 4 is displayed.

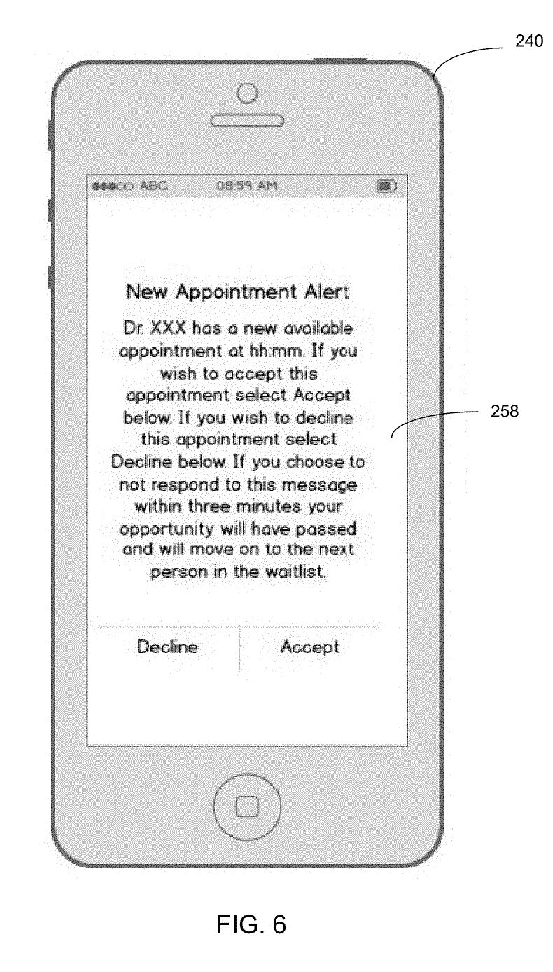

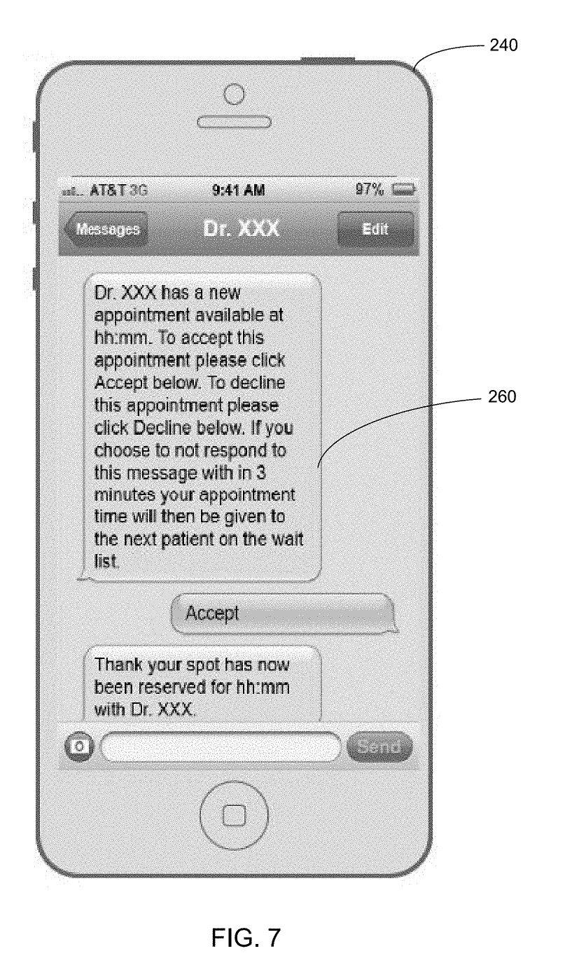

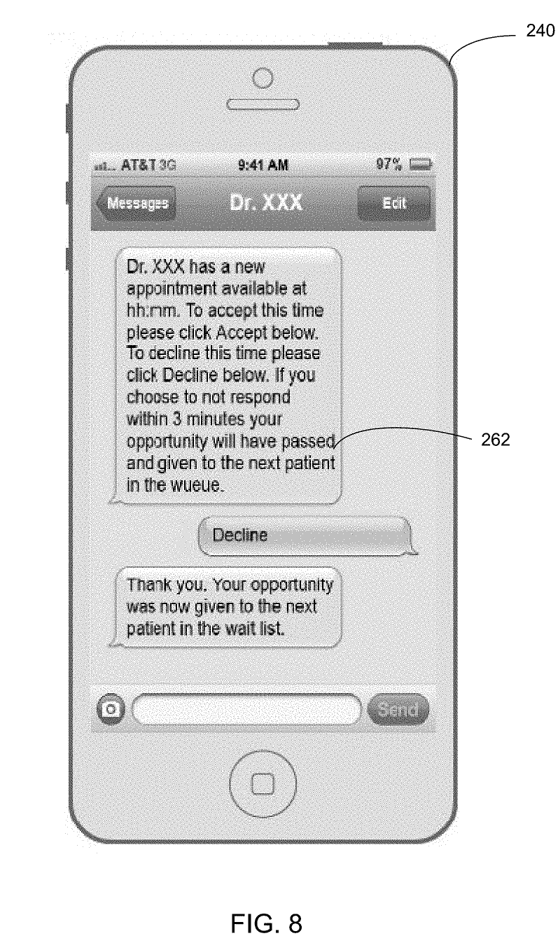

FIG. 6 is an illustration of a new appointment alert 58 being displayed on the mobile device 240. The patient can select the decline tab or the accept tab. If the patient clicks the accept tab, then the accept screen 260 shown in FIG. 7 is displayed and confirms that the appointment data and time has been accepted by the patient. The response is received from the patient at the server, and a confirmation notice is transmitted to the medical provider when the response indicates the compatible patient confirmed the available appointment. If the patient clicks the decline tab, then the decline screen 262 shown in FIG. 8 is displayed. As described above, then the system will select a next compatible patient with a next highest priority value on the list when the patient declines the available appointment. Alternatively, if the patient does not click the accept or decline tabs and the process times out, then the timed-out screen 264 shown in FIG. 8 is displayed.

The system 210 is designed as an add-on to an existing patient scheduling system 232. The server user interface 224 allows an operator to transfer data from the scheduling system 232 and format it for use with the system 210. The server user interface 224 also allows an operator to monitor patient cancellation notifications.

The functionality of the server user interface 224 is described by the functions that import and export data among the scheduling system 232, and the patient's mobile application 228. Also, facilities to modify the data stored internally are provided. For example,
(MDconnectServerUI)≡
   (Import functions)
   (Modify MDconnect data)
   (Export functions)

The import functions provide a mechanism to populate the files from the scheduling system 232. Without specific knowledge and integration with a scheduling system 232, these functions are stubs.
(Import functions)≡
(Populate diseases treated)
(Populate insurance providers)
(Populate visit reasons)
(Populate priority weights)
(Populate list of waiting patients)

The operator of the system 210 has the capability to update each file used in filling cancelled appointments. Standard file management may also be provided. The implementations are not provided here as they are known to one of ordinary skill in the art.
(Modify MDconnect data)≡
(Edit diseases treated)
(Edit insurance providers)
(Edit visit reasons)
(Edit priority weights)
(Edit list of waiting patients)

Given a positive patient response accepting a cancelled appointment, the system 210 is configured to update the scheduling system's appointments. Without specific knowledge and integration with a scheduling system 232, these function are stubs.
(Export functions)≡
(Update appointment schedule)

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed and may include other service provider-client relationships, and that modifications and embodiments are intended to be included within the scope of the appended claims.

That which is claimed is:

1. A method for transmission of appointment data, the method comprising:
receiving an available appointment at a server sent from a medical provider over a communications network, the server comprising a processor and a memory that stores patient data and medical provider data, the processor configured to
prioritize a list of waiting patients for the available appointment based upon a priority value determined from the patient data and the medical provider data,
identify a compatible patient for the available appointment based upon a highest priority on the list of waiting patients,
generate an appointment alert that contains a date and time for the available appointment,
format the appointment alert according to an appointment format, and
transmit the formatted appointment alert over a wireless communication channel to a wireless device associated with the compatible patient based upon a destination address associated therewith.

2. The method of claim 1, further comprising: receiving a response from the compatible patient at the server; and
transmitting a confirmation notice to the medical provider when the response indicates the compatible patient confirmed for the available appointment.

3. The method of claim 1, wherein the processor is configured to select a next compatible patient with a next highest priority value on the list when the compatible patient does not confirm the available appointment.

4. The method of claim 1, wherein the processor is configured to assign a primary weight to prioritize at least one of an insurance provider, a symptom, and a reason for an appointment, for each waiting patient.

5. The method of claim 4, wherein the processor is configured to assign a secondary weight to prioritize to at least one of a particular insurance provider, a particular symptom, and a particular reason for the appointment for each waiting patient.

6. The method of claim 5, wherein the processor is configured to compute the priority value for each waiting patient based on a respective primary weight and secondary weight.

7. The method of claim 1, further comprising providing a patient mobile application for the formatted appointment alert for installation on the wireless devices of the waiting patients.

8. The method of claim 7, wherein the formatted appointment alert activates the viewer application to cause the formatted appointment alert to be displayed on the wireless device.

9. The method of claim 1, wherein the patient data comprises at least one of the destination address, disease, and insurance provider for each waiting patient on the list.

10. The method of claim 1, wherein the formatted appointment data comprises at least one of an identity of the medical provider, a length of the available appointment, and a date and time for the available appointment.

11. The method of claim 1, wherein the destination address comprises a cell phone number associated with the compatible patient.

12. The method of claim 1, wherein the patient data is stored on a scheduling system of the medical provider that is in communication with the server.

13. A system for transmission of appointment data comprising:
a server comprising a processor and a memory coupled thereto, the server configured to receive an available appointment sent from a medical provider over a communications network;
the memory configured to store patient data and medical provider data; and
the processor configured to cooperate with the memory to
prioritize a list of waiting patients for the available appointment based upon a priority value determined from the patient data and the medical provider data,
identify a compatible patient for the available appointment based upon a highest priority on the list of waiting patients,
generate an appointment alert that contains a date and time for the available appointment,
format the appointment alert according to an appointment format, and
transmit the formatted appointment alert over a wireless communication channel to a wireless device associated with the compatible patient based upon a destination address associated therewith.

14. The system of claim 13, wherein the processor is configured to
receive a response from the compatible patient, and
transmit a confirmation notice to the medical provider when the response indicates the compatible patient confirmed for the available appointment.

15. The system of claim 13, wherein the processor is configured to select a next compatible patient with a next highest priority value on the list when the compatible patient does not confirm the available appointment.

16. The system of claim 13, wherein the processor is configured to assign a primary weight to prioritize to at least one of an insurance provider, a symptom, and a reason for an appointment, for each waiting patient.

17. The system of claim 16, wherein the processor is configured to assign a secondary weight to prioritize to at least one of a particular insurance provider, a particular symptom, and a particular reason for the appointment for each waiting patient.

18. The system of claim 17, wherein the processor is configured to compute the priority value for each waiting patient based on a respective primary weight and secondary weight.

19. A non-transitory computer-readable medium for operating a system for transmission of appointment data comprising a server configured to receive an available appointment sent from a medical provider over a communications network, a memory configured to store patient data and medical provider data, and the non-transitory computer-readable medium having computer-readable instructions for performing steps, the steps comprising:
prioritizing a list of waiting patients for the available appointment based upon a priority value determined from the patient data and the medical provider data,
identifying a compatible patient for the available appointment based upon a highest priority on the list of waiting patients,
generating an appointment alert that contains a date and time for the available appointment,
formatting the appointment alert according to an appointment format, and
transmitting the formatted appointment alert over a wireless communication channel to a wireless device associated with the compatible patient based upon a destination address associated therewith.

20. The non-transitory computer-readable medium of claim 19, further having computer-readable instructions for performing the steps comprising:
receiving a response from the compatible patient at the server;
transmitting a confirmation notice to the medical provider when the response indicates the compatible patient confirmed for the available appointment; and
selecting a next compatible patient with a next highest priority value on the list when the compatible patient does not confirm the available appointment.
